(19) United States
(12) Patent Application Publication
(10) Pub. No.: US 2021/0023721 A1
(43) Pub. Date: Jan. 28, 2021

(54) MATRIX CONFIGURED GRILL APPARATUS

(71) Applicant: TAYLOR COMMERCIAL FOODSERVICE, LLC, Rockton, IL (US)

(72) Inventor: James J. Minard, Rockton, IL (US)

(21) Appl. No.: 16/647,132

(22) PCT Filed: Oct. 4, 2018
(86) PCT No.: PCT/US2018/054341

§ 371 Date: Mar. 13, 2020

Related U.S. Application Data
(60) Provisional application No. 62/569,083, filed on Oct. 6, 2017.

(51) Int. Cl. B25J 11/00; B25J 9/02; A47J 37/06; A47J 43/00; G05B 19/4155

(52) U.S. Cl. CPC B25J 11/0045; B25J 9/023; G05B 2219/45111; A47J 43/00; G05B 19/4155; A47J 37/0676

(57) ABSTRACT

Disclosed is a cooking system having a matrix configured grilling apparatus that includes a plurality of grill modules forming a grid of grills, each grill in the plurality of grill modules being thermally isolated, having an egress for inserting and removing foodstuff, and being individually and digitally controllable, and a movable end effector that is digitally controllable and that inserts and removes foodstuff from each grill of the plurality of grill modules.

### CROSS-REFERENCE TO RELATED APPLICATIONS

This application claims priority from U.S. Provisional Application No. 62/569,083, filed on Oct. 6, 2017, the entirety of which is hereby fully incorporated by reference herein.

### BACKGROUND

Exemplary embodiments pertain to the art of grilling systems and more specifically to a grilling system that includes a matrix of grills.

Owners of fast food type eateries may be concerned with a variety of factors that may impact their ability to compete. Such factors may include the cost of labor and the ability to meet a brand standard for food quality and consistency. A flexible cooking process may enable growth and enable surviving periods of contraction driven by market conditions. Managers of such eateries may be concerned with the ability to maintain quality and throughput regardless of who is operating grilling cooking implements. A manager's efficiency may be impacted by their ability to optimize the percentage of food cooked vs the percentage of food sold, e.g., measuring waste. In addition, a clean and sterile environment is essential. However employers and managers have a limited and exhaustible bandwidth for monitoring and controlling store environmental dynamics.

### BRIEF DESCRIPTION

Disclosed is a cooking system comprising: a matrix configured grilling apparatus that includes a plurality of grill modules forming a grid of grills, each grill in the plurality of grill modules being thermally isolated, having an egress for inserting and removing foodstuff, and being individually and digitally controllable, and a movable end effector that is digitally controllable and that inserts and removes foodstuff from each grill of the plurality of grill modules.

In addition to one or more of the features described above, or as an alternative, further embodiments may include that the plurality of grill modules each includes a single grill.

In addition to one or more of the features described above, or as an alternative, further embodiments may include that the plurality of grill modules comprises a plurality of rows of grills forming an integrated module.

In addition to one or more of the features described above, or as an alternative, further embodiments may include that the plurality of grill modules comprises a plurality of columns of grills forming an integrated module.

In addition to one or more of the features described above, or as an alternative, further embodiments may include that each grill in each module of grills is shaped as a rectangular parallelepiped.

In addition to one or more of the features described above, or as an alternative, further embodiments may include a first articulating arm, which is digitally controllable and includes a first end effector to insert and remove foodstuff in each grill.

In addition to one or more of the features described above, or as an alternative, further embodiments may include a gantry system which is digitally controllable and includes an end effector to insert and remove foodstuff in each grill.

In addition to one or more of the features described above, or as an alternative, further embodiments may include that the gantry system includes a plurality of gantry track components that are digitally controllable to control placement of the end effector.

In addition to one or more of the features described above, or as an alternative, further embodiments may include that the gantry system includes a vertical track component that raises and lowers the end effector.

In addition to one or more of the features described above, or as an alternative, further embodiments may include that the gantry system further includes a plurality of horizontal track components to horizontally position the end effector.

In addition to one or more of the features described above, or as an alternative, further embodiments may include that the plurality of horizontal track components includes a first horizontal track component that moves the end effector parallel to a front plane of the grill matrix.

In addition to one or more of the features described above, or as an alternative, further embodiments may include that the plurality of horizontal track components includes a second horizontal track component that moves the end effector perpendicularly to the front plane of the grill matrix.

In addition to one or more of the features described above, or as an alternative, further embodiments may include that the first articulating arm controls the first end effector to insert and remove foodstuff from a front-side of the matrix configured grilling apparatus, and the system further includes a rear-side articulating arm, which is digitally controllable and includes a rear-side end effector to insert and remove foodstuff from a rear-side of the matrix configured grilling apparatus.

In addition to one or more of the features described above, or as an alternative, further embodiments may include that the gantry system includes an overhead track system for moving the end effector between a front-side of the matrix configured grilling apparatus and a rear-side of the matrix configured grilling apparatus to insert and/or remove foodstuff from a front-side of the matrix configured grilling apparatus and a rear-side of the matrix configured grilling apparatus.

In addition to one or more of the features described above, or as an alternative, further embodiments may include that the first end effector includes one or more of a spatula, tongs, a fork, a spoon and a knife.

In addition to one or more of the features described above, or as an alternative, further embodiments may include that the end effector includes one or more of a spatula, tongs, a fork, a spoon and a knife.

In addition to one or more of the features described above, or as an alternative, further embodiments may include that each end effector includes one or more of a spatula, tongs, a fork, a spoon and a knife.

In addition to one or more of the features described above, or as an alternative, further embodiments may include a digital controller that communicates over a network to individually control each grill, the first articulating arm and the first end effector.

In addition to one or more of the features described above, or as an alternative, further embodiments may include that a digital controller that communicates over a network to individually control each grill, the gantry system and the end effector.

In addition to one or more of the features described above, or as an alternative, further embodiments may include that a digital controller that communicates over a network to individually control each grill, each articulating arm and each end effector.

### BRIEF DESCRIPTION OF THE DRAWINGS

The following descriptions should not be considered limiting in any way. With reference to the accompanying drawings, like elements are numbered alike:

FIG. 1 illustrates a matrix configured grilling apparatus according to a disclosed embodiment; and

FIG. 2 illustrates a matrix configured grilling apparatus according to a disclosed embodiment.

### DETAILED DESCRIPTION

A detailed description of one or more embodiments of the disclosed apparatus and method are presented herein by way of exemplification and not limitation with reference to the Figures.

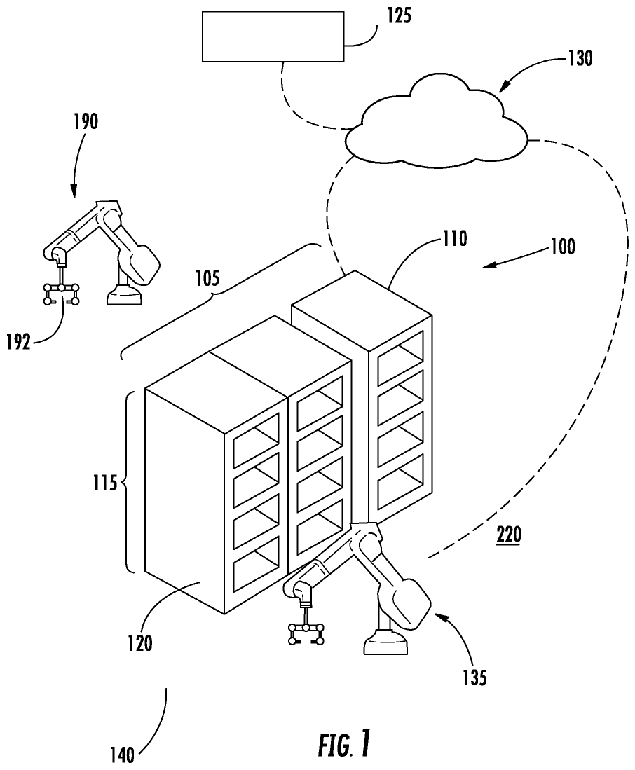

Turning to FIG. 1, the disclosed embodiments may provide a matrix configured grilling apparatus (or grill matrix) 100. The grill matrix 100 may include a plurality of grill modules (or sets) 105 forming a grid of grills. As illustrated in FIG. 1, the plurality of grill modules 105 are provided as a plurality of columns (or stacks) of grills 105 including a first column of grills 110. Each module 105 or set of grills may be an integrated unit of thermally isolated and individually controllable grills.

In FIG. 1, each of the columns of grills 105 may include a plurality of vertically stacked grills 115, including a first grill 120 forming a base of the column of grills 115. Each grill may be shaped as a rectangular parallelepiped (or box) and have at least a front-side food egress area that is rectangular shaped and large enough to receive one item or a few items at a time. Each grill is long enough to house the same foodstuff during a cooking cycle. In addition, each grill in the matrix 100 may accept multiple types of foodstuff that vary in thickness.

In a fast food establishment, each grill may be sized to fit one or two hamburger patties or a bun or a few hotdogs, etc. By making the grills in a compact form, a maximum energy transfer may be provided in each grill so as to quickly and efficiently cook each item via, e.g., convection, conduction, induction, microwaves or the like. Columns of grills 115 may be added or removed depending on usage needs. One of ordinary skill would appreciate that a large matrix containing many grills may be desirable in densely populated locations that consume mass quantities of foodstuff.

Operation of each grill may be individually controlled by a schematically illustrated digital controller 125, such as a computer, which may be connected via an electronic communications network 130. Each grill in the matrix 100 may be capable of providing compression on the foodstuff being grilled or cooked in a food preparation cycle.

The above disclosed distribution of grills in a matrix is not limiting. Instead of a plurality of columns of grills 105, a matrix 100 may comprise a plurality of rows of grills (not illustrated) where the grills in the row may form an integrated unit. Or further, each grill in a matrix 100 may be individually addable or removable.

As illustrated in FIG. 1 foodstuff may be inserted and removed from each grill in the matrix 100 via a first articulating arm 135 which is digitally controllable fitted and with a first end effector 140 suitable for the purpose. For handling hamburgers or other flat foodstuff an end effector 140 may include a spatula. For hotdogs and other oblong foodstuff an end effector 140 may include tongs. For other kinds of foodstuff an end effector may include a fork, a spoon and/or a knife. End effectors may comprise a plurality of articulating extensions that function to place any and all kinds of foodstuff in a grill. Each articulating extension may one food preparing implement, e.g., a spatula, tongs, a fork, a spoon, a knife, etc.

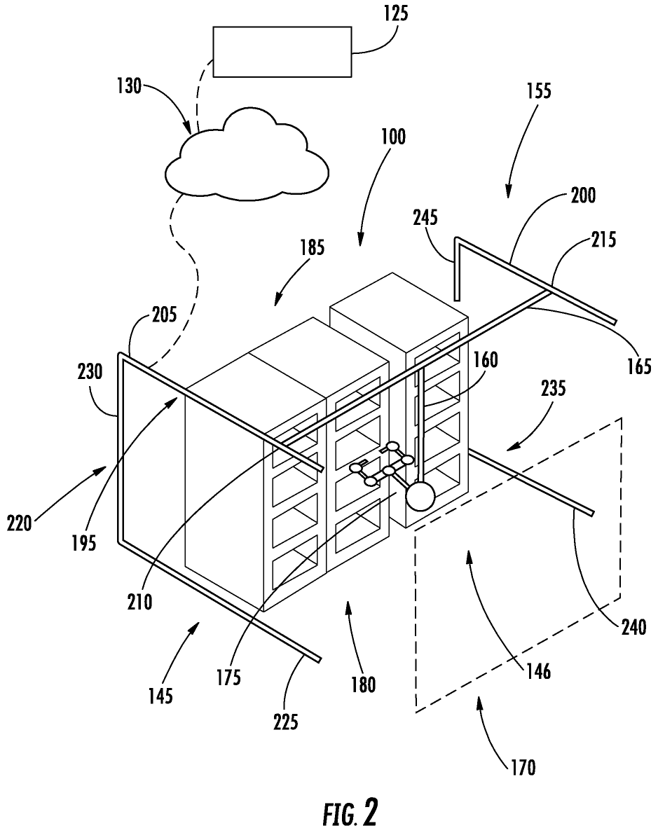

Instead of an articulating arm 135 a digitally controllable gantry system 145 may be utilized for placement and removal of foodstuff as illustrated in FIG. 2. A second end effector 150 may have the same foodstuff handling capabilities as the first end effector 140. The second end effector 150 may be capable of moving vertically and in a horizontal plane by action of digitally controllable gantry track components 155.

The gantry track components 155 include a vertical track component 160 that raises and lowers the end effector 140. In addition, the gantry system 145 further includes a plurality of horizontal track components 146 to horizontally position the end effector 140 and insert or remove foodstuff from each grill. The horizontal track components 146 include a first horizontal track component 165 moves the end effector 140 parallel to a front plane 170 of the grill matrix 100. A second horizontal track component 175 moves the end effector 140 perpendicularly to the front plane 170 of the grill matrix 100. The combination of the horizontal track components enable placement and removal of foodstuff into each grill.

In an embodiment the grills may be accessible on both a front side 180 of the grill matrix 100 and a rear side 185 of the grill matrix 100. When accessible on the rear side 185 of the grill matrix 100 a second (or rear-side) articulating arm 190 with a third (or rear-side) end effector 192 as illustrated in FIG. 1 may be utilized. The rear-side articulating arm 190 and rear-side end effector 192 have the same features and capabilities as the first articulating arm 135 and first end effector 140. For a gantry system 145, access to the rear side 185 of the grill matrix 100 may be achieved by motion of an overhead horizontal track system 195. The overhead horizontal track system may move the first horizontal track component 165 between the front side of the grill matrix 100 and the rear side of the grill matrix 100.

The overhead horizontal track system (or overhead track system) 195 may include a fourth horizontal track component 200 and a fifth horizontal track component 205. The fourth horizontal track component 200 and fifth horizontal track component 205 may respectively connected to a first end 210 of the first horizontal track component 165 and an opposing second end 215 of the first horizontal track component 165. The fourth horizontal track component may be supported by a first L shaped stand 220 with a first base member 225 and a first vertical member 230. The fifth horizontal track component 205 may be supported off the ground by a second L shaped stand 235 with a second base member 240 and a second vertical member 245.

A configuration (not illustrated) that uses a combination of the above disclosed first articulating arm 135, second articulating arm 190 and the gantry system 145 may be desirable based on space and usage requirements of the grill matrix 100. In certain embodiments, the first articulating arm 135, second articulating arm 190 and the gantry system 145 may be usable to add or remove grill modules to increase or decrease the size of the grill matrix 100 and/or for cleaning grills.

The disclosed embodiments provide a compact footprint that allows the cooking of products as well as allowing for matrix expansion or contraction as needed through the addition or removal of modules.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cooking system comprising:
a matrix configured grilling apparatus that includes a plurality of grill modules forming a grid of grills, each grill in the plurality of grill modules being thermally isolated, having an egress for inserting and removing foodstuff, and being individually and digitally controllable, and
a movable end effector that is digitally controllable and that inserts and removes foodstuff from each grill of the plurality of grill modules.

2. The system of claim 1 wherein the plurality of grill modules each includes a single grill.

3. The system of claim 1 wherein the plurality of grill modules comprises a plurality of rows of grills forming an integrated module.

4. The system of claim 1 wherein the plurality of grill modules comprises a plurality of columns of grills forming an integrated module.

5. The system of claim 1 wherein each grill in each module of grills is shaped as a rectangular parallelepiped.

6. The system of claim 1 further including a first articulating arm, which is digitally controllable and includes a first end effector to insert and remove foodstuff in each grill.

7. The system of claim 1 further including a gantry system which is digitally controllable and includes an end effector to insert and remove foodstuff in each grill.

8. The system of claim 7 wherein the gantry system includes a plurality of gantry track components that are digitally controllable to control placement of the end effector.

9. The system of claim 8 wherein the gantry system includes a vertical track component that raises and lowers the end effector.

10. The system of claim 9 wherein the gantry system further includes a plurality of horizontal track components to horizontally position the end effector.

11. The system of claim 10 wherein the plurality of horizontal track components includes a first horizontal track component that moves the end effector parallel to a front plane of the grill matrix.

12. The system of claim 11 wherein a plurality of horizontal track components includes a second horizontal track component that moves the end effector perpendicularly to the front plane of the grill matrix.

13. The system of claim 6 wherein the first articulating arm controls the first end effector to insert and remove foodstuff from a front-side of the matrix configured grilling apparatus, and the system further includes a rear-side articulating arm, which is digitally controllable and includes a rear-side end effector to insert and remove foodstuff from a rear-side of the matrix configured grilling apparatus.

14. The system of claim 12 wherein the gantry system includes an overhead track system for moving the end effector between a front-side of the matrix configured grilling apparatus and a rear-side of the matrix configured grilling apparatus to insert and/or remove foodstuff from a front-side of the matrix configured grilling apparatus and a rear-side of the matrix configured grilling apparatus.

15. The system of claim 6 wherein the first end effector includes one or more of a spatula, tongs, a fork, a spoon and a knife.

16. The system of claim 7 wherein the end effector includes one or more of a spatula, tongs, a fork, a spoon and a knife.

17. The system of claim 13 wherein each end effector includes one or more of a spatula, tongs, a fork, a spoon and a knife.

18. The system of claim 6 including a digital controller that communicates over a network to individually control each grill, the first articulating arm and the first end effector.

19. The system of claim 7 including a digital controller that communicates over a network to individually control each grill, the gantry system and the end effector.

20. The system of claim 13 including a digital controller that communicates over a network to individually control each grill, each articulating arm and each end effector.
